(19) United States
(12) Patent Application Publication
(10) Pub. No.: US 2010/0293575 A1
(43) Pub. Date: Nov. 18, 2010

(54) LIVE INDEXING AND PROGRAM GUIDE

(76) Inventor: BRYAN BINIAK, Los Angeles, CA (US)

Correspondence Address: DLA PIPER US LLP, 1999 AVENUE OF THE STARS, SUITE 400, LOS ANGELES, CA, 90067-6023, US

(21) Appl. No.: 12/778,890

(22) Filed: May 12, 2010

Related U.S. Application Data
(60) Provisional application No. 61/177,617, filed on May 12, 2009.

(51) Int. Cl. H04N 5/445

(52) U.S. Cl. 725/40

(57) ABSTRACT

The system provides a program guide that uses advance or contemporaneous indexing to provide richer content descriptions than in the prior art. For example, if a program is in progress, the present system will present a program guide with a general description and additional description of what is currently being presented along with what has previously happened in the program. For example, if the program is a live sporting event, the system will let you know the score, the time, which players are playing, and the outcomes of prior plays. If it is a reality competition, the guide will let the user know which contestant is currently featured and the status of the other contestants, as well as what the current activity may be.

This patent application claims priority to U.S. Provisional Patent Application 61/177,617 filed on May 12, 2009 which is incorporated by reference herein in its entirety.

### BACKGROUND OF THE SYSTEM

1. Field of the Invention

The invention relates generally to a system of providing indexing and content information to content presentations.

2. Background of the Invention

The television broadcast experience has not changed dramatically since its introduction in the early 1900s. In particular, live and prerecorded video is transmitted to a device, such as a television, liquid crystal display device, computer monitor and the like, while viewers passively engage.

With broadband Internet adoption and mobile data services hitting critical mass, television is at a cross roads faced with:
Declining Viewership
Degraded Ad Recognition
Declining Ad Rates & Spend
Audience Sprawl
Diversionary Channel Surfing
Imprecise and Impersonal Audience Measurement Tools
Absence of Response Mechanism
Increased Production Costs

In addition, there is a tremendous increase in the number of people that have high speed (cable model, DSL, broadband, etc.) access to the interne so that it is easier for people to download content from the internet. There has also been a trend in which people are accessing the Internet while watching television. Thus, it is desirable to provide a parallel programming experience that is a reinvigorated version of the current television broadcast experience that incorporates new Internet based content.

Attempts have been made in the prior art to provide a computer experience coordinated with an event on television. For example, there are devices (such as the “slingbox”) that allow a user to watch his home television on any computer. However, this is merely a signal transfer and there are no additional features in the process.

Another approach is to supplement a television program with a simultaneous internet presentation. An example of this is known as “enhanced TV” and has been promoted by ABC. During an enhanced TV broadcast, such as of a sporting event, a user can also log onto abc.com to participate in a preprogrammed and or pre-produced content and applications that have been created explicitly for a synchronous experience with the broadcast. The underlining disadvantage to this approached is that the user is limited to only the data made available by the website, and has no ability to customize or personalized the data that is being associated with the broadcast.

Other approaches include game-casts providing historical and post-play statistical data, and asynchronous RSS widgets.

All of the prior art systems lack customizable tuning of secondary content, user alerts, social network integration, interactivity, user generated content and synchronization to a broadcast instead of to an event.

Another problem with the prior art broadcast experience is the passive and static presentation of program information. Many program guides are printed (such as in the newspaper) or are part of a service provider package. For example, cable TV provides a program guide channel that scrolls through the channels showing a current schedule and the next few hours of programming.

Another prior art programming guide overlays a current channel with a scrollable program guide where the user can select a channel and see what is currently on the channel and what is coming up, often over an extended time period of several days, or even weeks ahead. Digital Video Recorders (DVR's) often have their own proprietary program guides, typically providing two weeks worth of data.

A disadvantage of all of these program guides is their lack of specific information. If content is in progress, the guide does not change. The content description stays the same whether the content is at its beginning or at its end.

### SUMMARY OF THE SYSTEM

The system provides a program guide that uses advance or contemporaneous indexing to provide richer content descriptions than in the prior art. For example, if a program is in progress, the present system will present a program guide with a general description and additional description of what is currently being presented along with what has previously happened in the program. For example, if the program is a live sporting event, the system will let you know the score, the time, which players are playing, and the outcomes of prior plays. If it is a reality competition, the guide will let you know which contestant is currently featured and the status of the other contestants, as well as what the current activity may be.

In addition to the dynamic and updated program guide, the system may provide in one or more embodiments associated content from secondary sources that is related to the primary (broadcast) content. This secondary content can include images, commercial offers, articles, blogs, twitter feeds, audio/video content, chat rooms, and the like.

### BRIEF DESCRIPTION OF THE DRAWINGS

FIG. 1 is a block diagram of an embodiment of the system.

FIG. 2 is a flow diagram illustrating operation of an embodiment of the system.

FIG. 3 is a flow diagram illustrating operation of another embodiment of the system.

FIGS. 4-8 are examples of a display of an embodiment of the system.

FIG. 9 is an example of a human assisted indexing template.

FIG. 10 is an example computer embodiment of the system.

FIG. 11 is a flow diagram illustrating the definition of summary blocks in an embodiment of the system.

FIG. 12 is a flow diagram illustrating the creation of summary descriptions in an embodiment of the system.

### DETAILED DESCRIPTION OF THE SYSTEM

The present system provides a dynamically indexed program guide in substantially real time. In one embodiment, the system provides associated secondary content with the content and/or the program guide itself.

The system can be used in conjunction with the system described in “Social Media Platform & Method”, U.S. patent application Ser. No. 11/540,748 and in “System for Providing Secondary Content Based on Primary Broadcast, U.S. patent application Ser. No. 11/849,239 both of which are incorporated herein in their entirety by reference. In addition, the system can be used independently or in conjunction with traditional content delivery systems.

Functional Block Diagram

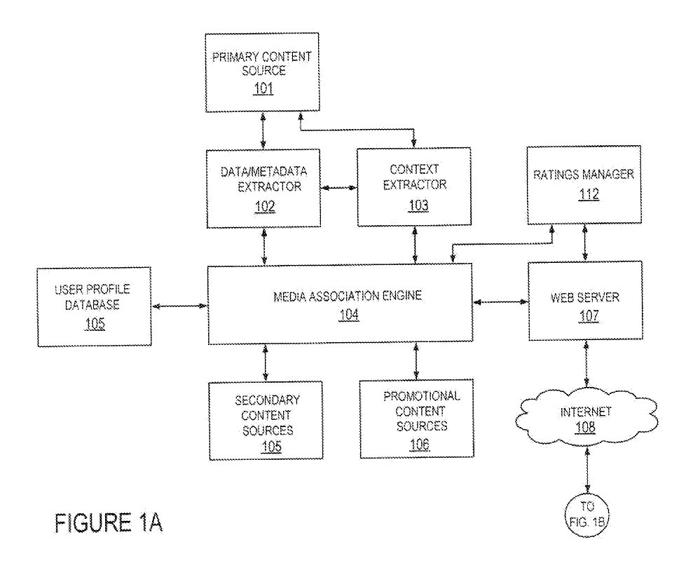

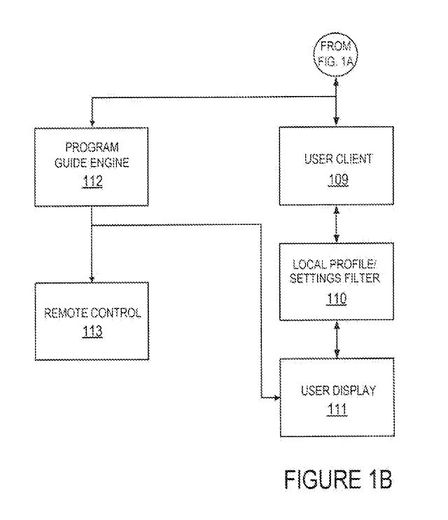

FIG. 1 is a functional block diagram illustrating an embodiment of the system. Block 101 is a primary content source. The primary content source may be a television broadcast or any other suitable primary content source. The primary content source 101 is coupled to data/metadata extractor 102 and context extractor 103. The data/metadata extractor 102 extracts metadata such as cc text, audio data, image data, and other related metadata, as well as data from the primary content source itself. The context extractor 103 is coupled to the primary content source 101 and to the data/metadata extractor 102 and is used to extract context information about the primary content source 101.

The data/metadata extractor 102 and context extractor 103 provide output to media association engine 104. The media association engine 104 uses the metadata and context data to determine what secondary content and promotional content to be provided to a user. The media association engine 104 is coupled to a user profile database 112 which contains profile information about the registered users of the system. The media association engine 104 provides requests to secondary content source 105 and promotional content source 106. In one embodiment, the media association engine also provides data to the program guide engine 112 that in turn provides guide information to a user display 111 or to a stand-alone remote control 113 In one embodiment the stand-alone remote control includes a display that may be a touch screen display.

Secondary content source 105 can draw content from commercial sources 105 such as from one or more web sites, databases, commercial data providers, or other sources of secondary content. The request for data may be in the form of a query to an interne search engine or to an aggregator web site such as Youtube, Flickr, or other user generated media sources. Alternatively, the secondary content can be user generated content 114. This content can be chats, blogs, homemade videos, audio files, podcasts, images, or other content generated by users. The users may be participating and/or registered users of the system or may be non-registered third parties.

The promotional content sources 106 may be a local database of prepared promotional files of one or more media types, or it could be links to servers and databases of advertisers or other providers of promotional content. In one embodiment, the promotional content may be created dynamically, in some cases by “mashing” portions of the secondary content with promotional content.

The media association engine 104 assembles secondary content and promotional content to send to users to update user widgets. The assembled content is provided via web server 107 to a user, such as through the interne 108. A user client 109 receives the assembled secondary and promotional content updates and applies a local profile/settings filter 110. This filter tracks the active widgets of the user, team preferences, client processing capabilities, user profile information, and other relevant information to determine which widgets to update and with which information. User display 111 displays user selected widgets and are updated with appropriate content for presentation to the user.

The system includes a ratings manager 112 coupled to the media association engine 104 and the web server 107. The ratings manager 112 receives information about the primary content source, the secondary content source, user behaviour and interaction, user profile information, and metadata relating to the primary content, secondary content, and promotional content.

The ratings manager 112 can detect traditional ratings information such as the presence or absence of a viewer of the primary content. In addition, the ratings manager 112 has access to the user profile data and for all users accessing the system. So the system can not only provide comprehensive statistical information about the viewing and viewing interest of a user, but important demographic information as well. The system can provide real time and instantaneous geographic, age based, income based, gender based, and even favourite team based, data relating the response and viewership of consumers of the primary content.

The user generated content allows users to interact in real time about an event that they are experiencing together (e.g. the primary content broadcast). The system can utilize both found and provided user generated content. Found content includes user generated content that is found as the result of queries to sites that may include some or all user generated content (YouTube, Flickr, etc.). Provided content can be prepared content by a user that relates generally to the event (e.g. team or player discussions in blogs and podcasts, image, video, and/or audio presentations, etc.). Provided content can also be real-time generated content that is being provided during the primary content broadcast (e.g. podcasting, chatting, etc.).

In one embodiment, the system includes a chat widget that is tied to the particular broadcast event. The chat widget permits the user to define the user's own chat rooms. The chat widget can indicate presence, a buddy list, and context. By context the list could be populated by all viewers of a particular broadcast. In other instances, the widget could be populated by all of the buddies of the user who are viewing the broadcast. In some instances, the primary broadcast event is a sporting event or game. If there are other games being broadcast on other channels, the system provides a mechanism for a viewer of one game to still access chat widgets for other games. This may be via visual presentation of a limited number of recent posts from that chat widget, so that a view can scan the widgets from different games and elect to enter the widget if the viewer sees something of interest.

In one embodiment of the system, the secondary content that will be presented to the user is tied to the primary broadcast exclusively. In another embodiment, the secondary content that is provided to the user is tied to the chat widget content exclusively, whenever the user is actively using the chat widget. For example, if the primary broadcast is a sporting event, the chat users may be chatting about prior games, players or seasons related to one or more of the teams in the sporting event. The secondary content that is provided would then be tied to that conversation. If the chat is about a team from say, 2002, the statistics for the team from 2002 could be presented in a stat widget, images and multimedia about that team could be provided in a picture or video widget, and news stories about that team could be provided in a text widget.

In another embodiment, activation of the chat widget could cause a blend of secondary content, some of which relates to the primary broadcast and other of which relates to the chat content. In other embodiments, the chat widget itself could include frames or windows for secondary content specifically related to the chat while previously activated widgets tied to the primary broadcast continue to have their content tied to that primary broadcast.

The system provides the ability to search the text of the chat widget to provide key words to the media association engine to retrieve appropriate secondary content tied to those keywords and other meta data.

Program Guide Operation

The system provides a method and apparatus for providing live indexing and program guide for pre-recorded programs or for live programs.

Pre-Recorded Content

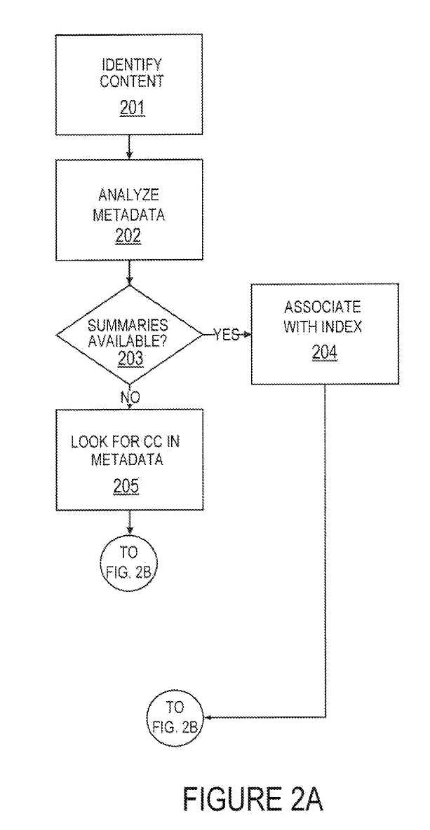

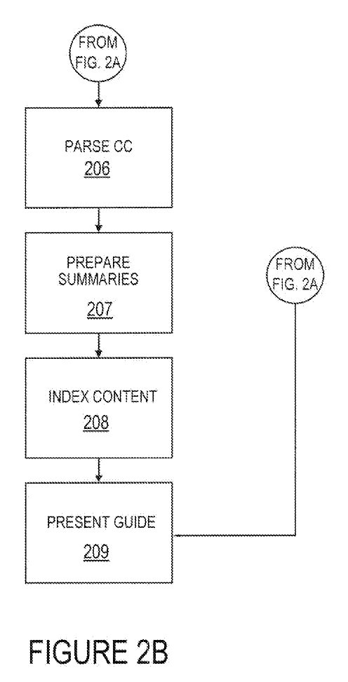

FIG. 2 is a flow diagram illustrating the operation of an embodiment of the program guide of the system for a pre-recorded show that can be pre-processed. At step 201 the show to be pre-processed is identified. At step 202 metadata associated with the show is analyzed. At decision block 203 it is determined if the metadata includes scene and/or act summaries. If so, at step 204 these summaries are associated with running time of the content.

If not, the metadata is analyzed for close captioning information at step 205. If there is close captioning content, that content is parsed at step 206 and summaries of scenes are prepared based on the closed captioning at step 207. These summaries may include the character names appearing on screen, a summary of the dialogue, or other identifying summary characteristics. These generated summaries are also tied to and associated with the running time of the content at step 208.

When the guide is presented at step 209, the current time is compared to running time cues in the content. The appropriate summary descriptions are displayed at step 210 and the display or remote are updated as appropriate. This takes place for each program that appears on the guide.

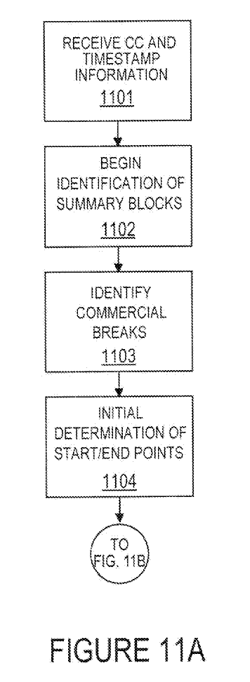

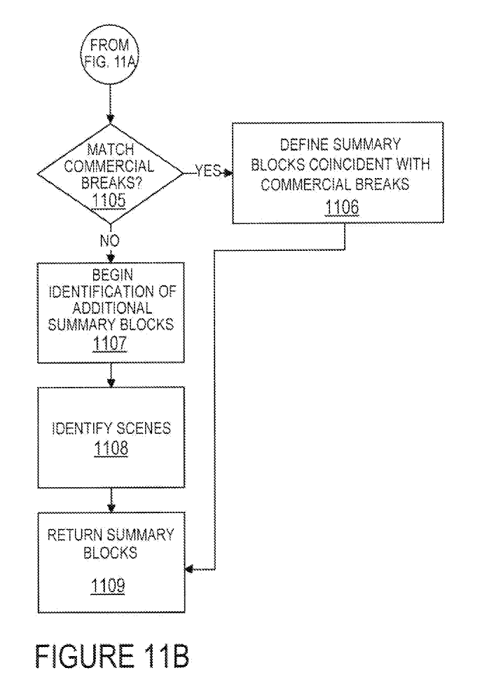

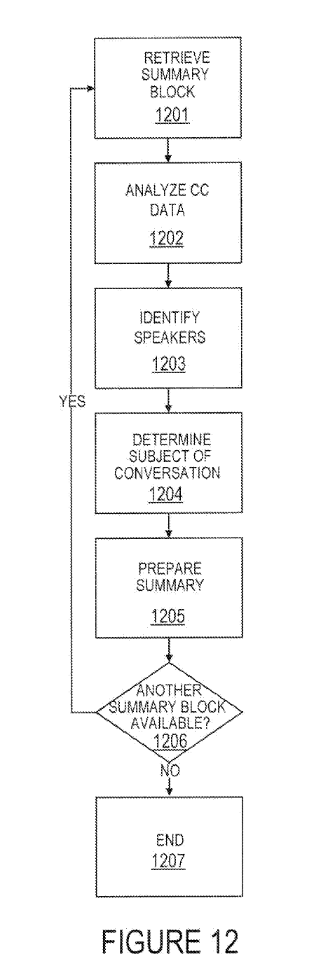

The step of preparing summaries for the live indexing in one embodiment is illustrated in more detail in FIGS. 11 and 12. FIG. 11 is a flow diagram illustrating the definition of summary blocks in one embodiment of the system. At step 1101 the system receives the parsed closed captioning information along with timestamps associated with the data. At step 1102 the system determines time blocks for which summaries will be prepared. At step 1103 the system checks for indications of commercial breaks in the data. If so, at step 1104, the system defines end points and start points for summaries based on commercial breaks. For example, the beginning of content after a commercial is designated as a start point of a summary block. The time just before a commercial break is defined as an end point of a summary block. At step 1105 the system determines if the summary blocks will be coincident with the breaks. If so, the system defines the summary blocks at step 1106 to match up with the breaks. This means that if there are two commercial breaks in a program, the system will define three summary blocks, a first block from beginning to the first break, a second block from the first break to the second break, and a third block from the second break to the end of the content.

If the summary blocks are not coincident with the commercial breaks at step 1105, the system proceeds to step 1107 and defines additional summary blocks. This means that there may be two or more summary blocks between commercial breaks. In one embodiment, the system attempts to identify scene changes at step 1108. A scene change may be indicated by closed captioning text that indicates a different time or location than the prior scene. In other cases, a scene change can be assumed when a certain number of speakers in a scene have changed. The system attempts to identify scenes and to define the summary blocks to be coincident with the scenes. Even if the summary blocks do not coincide perfectly with the actual perceived or defined scenes of the content, the system will still provide useful live indexing information.

Once the summary blocks have been defined, they are associated with timestamps to define their start points and end points and returned at step 1109. The system then proceeds to generate summaries as described in the flow diagram of FIG. 12.

FIG. 12 is a flow diagram illustrating the generation of summary descriptions for each summary block of the content. At step 1201a summary block is retrieved. At step 1202 the closed captioning content associated with the summary block is analyzed. At step 1203 the speakers in the scene are identified. At step 1204 the substance of the conversations are determined by the context and vocabulary of the dialogue. At step 1205 a summary is prepared that, in one embodiment, lists the participants in the summary block and a summary of their conversation. For example, the summary for a scripted program may be characters A, B, and C discuss vacation plans, or character A and B argue about marriage, or the like. The summary may also include a timestamp begin time, end time, and current time associated with the summary description so that a viewer will know how much longer the scene will last.

At step 1206 it is determined if another summary block is available for processing. If not, the system ends at step 1207. If so, the system returns to step 1201.

Special Case and Live Content

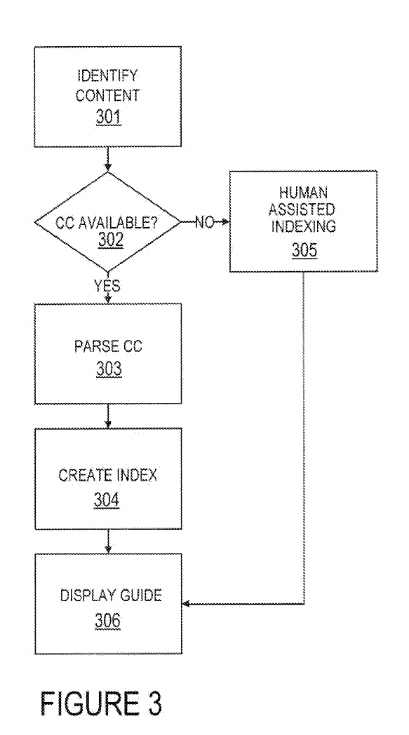

FIG. 3 is a flow diagram illustrating the operation of an embodiment of the system when the content is pre-recorded but there is not sufficient existing meta-data or pre-existing, close captioning to generate the summaries, or if the event is a live event. At step 301 the content to be summarized is identified. At step 302 it is determined if there is live closed captioning available in the content presentation. If so, the system parses the closed captioning at step 303 to dynamically generate summaries to be associated with the content as it is displayed. At step 304 the index is created and at step 306 a guide on a display and/or remote is updated as time passes to show the associated summary. If there is no CC available, human assisted indexing may be implemented at step 305.

In one alternate embodiment, human assisted indexing is used instead of, or in conjunction with, automated indexing, such as is described in connection with FIGS. 11 and 12.

It should be noted that when using the guide, the user is free to look back in time to see what has already taken place so that the user can get an idea of where things stand in the presentation of the content. This is also useful when the guide is coordinated with a DVR so that the user can more quickly go to a desired portion of the program. In one embodiment, the guide can be coordinated with the fast forward or rewind feature of a DVR so that the guide is updated while the forward or backward scan is operating. In another embodiment, the recorded show is indexed to the guide so that the user can just click on an entry in the guide and be taken to that portion of the program without scanning. It is like a live and dynamic chaptering system for presented content.

Presentation of Guide

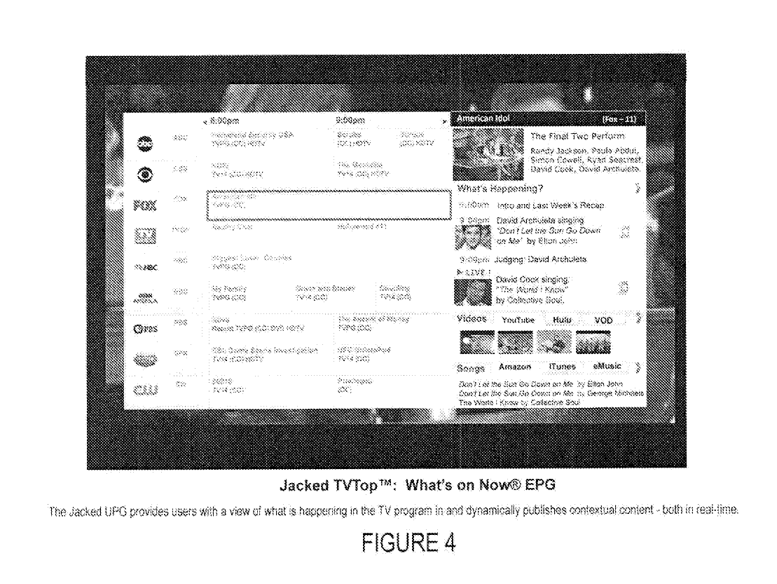

FIG. 4 is an example of an embodiment of the guide. In the embodiment of FIG. 4, the guide displays a current time slot (e.g. 8 pm and 9 pm) and displays the programs on various networks and channels at that time period. In the example shown, a user has selected “American Idol” starting at 8 pm. On the right side of the display, information is provided about the selected program at the current time. For example, a summary of the overall program is provided at the top of the screen. Below that, the indexing of the program from the beginning is indicated. The summaries gives the user information about the program in progress. If the program is being broadcast live, the guide includes a section of the display indicating “Live!” and informing the user of what is currently happening. The “Live!” indicator represents the current stage in the broadcast of the program. It performs the same function as “you are here” in a map, it tells you where you are in the current program. In this case, a performance by one of the contestants, including the name of the song being performed, is displayed. The bottom of the display includes links to secondary content that has been collected using the system described in conjunction with FIG. 1 and the system described in the patent applications noted above. In this case there are links to YouTube, Hulu, and VOD (video on demand) videos available that are related to the current content of the program. In one embodiment, as the user moves back and forth through the program guide, the secondary content will change to reflect the current subject matter of the program. This is also useful when the program is being viewed from a DVR, Tivo, or the like.

If the user where to select any of the other programs available, the display would reflect the current state of the program as well as any summaries that had already been provided for the program. As noted above, if the user is viewing via a DVR or the like, and fast forwards through the program, the guide may stay in place and update the summary descriptions during fast forwarding so that the user can more easily find a desirable scene or moment from the program.

The guide may be presented on a computer, as an overlay on the television screen, on a separate channel on the television, or on a remote control that includes a display screen.

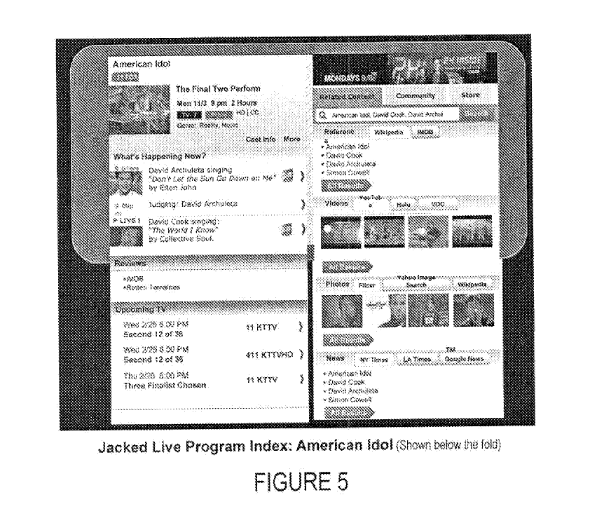

In one embodiment of the system, additional information is available that is not shown in the display of FIG. 4. This is referred to herein as “below the fold” and is shown in FIGS. 5-8. FIG. 5 shows additional information below the fold that can be accessed by scrolling the display or clicking on a reveal selector. The additional information can include reviews, upcoming episodes, news, images, etc. The display can include selector tabs (e.g. “Related Content”, “Community”, and “Store”) that can provide more information for the user. Selecting those tabs can cause the display of additional information in the same screen or can bring up a new screen depending on the embodiment.

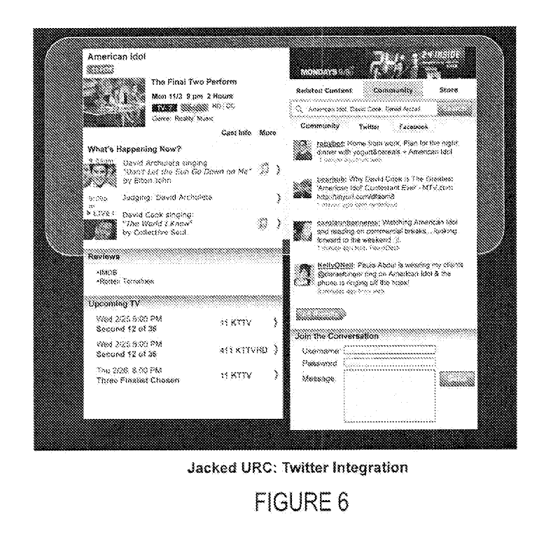

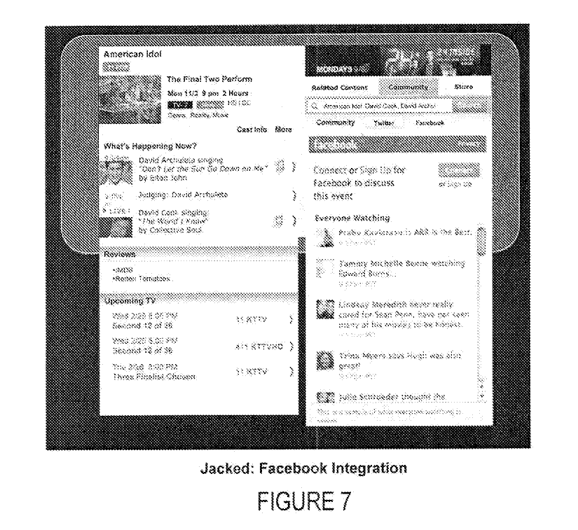

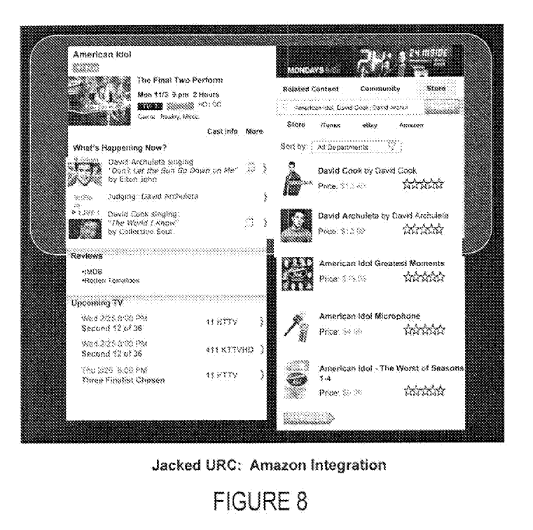

The Community tab can show twitter information (FIG. 6) or Facebook information (FIG. 7). The Store tab can show related merchandise at a vendor such as Amazon (FIG. 8). Referring to FIG. 6, the system can provide the official twitter account of the program being broadcast, as well as twitter accounts, if any, for the principals involved with the program. In other instances, the twitter can be a system provided account for the program where viewers can interact with comments about the broadcast. The twitter messages can be live or can be tied to the portion of the program being broadcast if the viewer is watching on a DVR or the like. FIG. 7 illustrates the selection of the Facebook tab of the community button. The system links to a Facebook page for the program where users can add comments during the broadcast. As with the twitter information, the user can choose to see realtime comments or to see comments as they appeared during broadcast of the program.

The system contemplates vendor site integration, such as the Amazon integration illustrated in FIG. 8. The system can display merchandise associated with the content being broadcast, such as CDs, books, Videos, DVDs, etc. related to the show. Here, in the example where American Idol has been selected, CDs, DVDs, and singing equipment (e.g. microphones) are offered for sale. In some cases, the vendor may offer simulcast specials that apply during the first airing of the program, to encourage viewing and discourage commercial skipping. In other embodiments, those special prices are not repeated when viewing via a DVR, for example.

In one embodiment of the system, the information extraction can be automated using the systems of context extraction described above. In other instances, human driven semantic indexing can be used to provide the related information. In other instances, a hybrid combined approach can be used as desired.

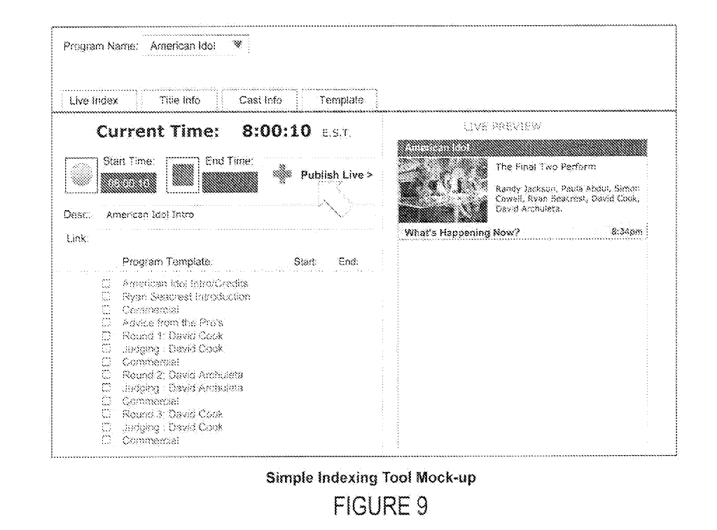

FIG. 9 is an example of an indexing tool data entry screen for human assisted indexing. The system provides a data entry screen that will work for most programs and content. The program name is selected and as much information that can be provided from metadata or database information about the program is used to populate the template. The template includes tabs for Title Info, Cast Info, and Template, as well as the Live Index tab which is used to enter summary information tied to the content.

A person would watch the content, either live content or content that does not include closed captioning that could be mined for information, and manually prepares summaries for time segments of the program. The template can include likely scene breaks that can be used, modified, and/or expanded by the person entering summaries. Here, the format of the show is somewhat know from previous shows, with title/credits, introduction, commercial breaks and the like already laid out. The user can check a box from the template and the start time for that summary block is indicated in the “start time box”. When another box is checked, the prior box has its end time set and the start time for the new box is determined. This allows the summaries to be matched up with time code of the program so that even if a viewer watches later via DVR, for example, the summary blocks will still be matched up with the content.

After a template box is selected, the user can enter a description of the summary block and when the description is complete, can select the “publish Live” button to complete the process.

Embodiment of Computer Execution Environment (Hardware)

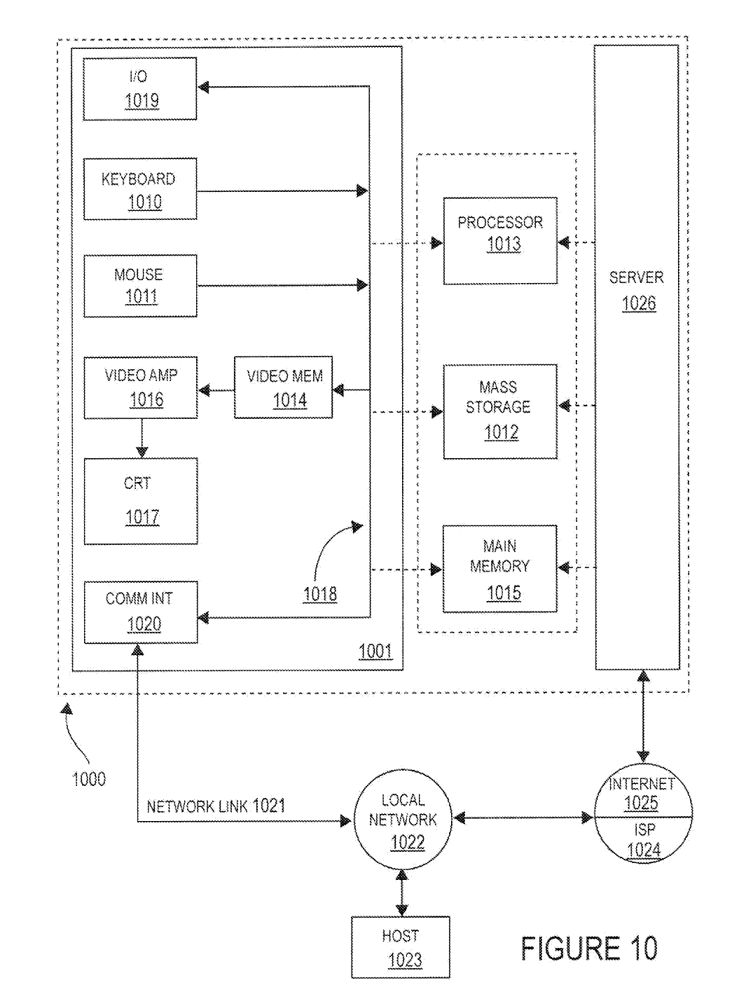

An embodiment of the system can be implemented as computer software in the form of computer readable program code executed in a general purpose computing environment such as environment 1000 illustrated in FIG. 10, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 1010 and mouse 1011 are coupled to a system bus 1018. The keyboard and mouse are for introducing user input to the computer system and communicating that user input to central processing unit (CPU 1013. Other suitable input devices may be used in addition to, or in place of, the mouse 1011 and keyboard 1010. I/O (input/output) unit 1019 coupled to bi-directional system bus 1018 represents such I/O elements as a printer, AN (audio/video) I/O, etc.

Computer 1001 may include a communication interface 1020 coupled to bus 1018. Communication interface 1020 provides a two-way data communication coupling via a network link 1021 to a local network 1022. For example, if communication interface 1020 is an integrated services digital network (ISDN) card or a modern, communication interface 1020 provides a data communication connection to the corresponding type of telephone line, which comprises part of network link 1021. If communication interface 1020 is a local area network (LAN) card, communication interface 1020 provides a data communication connection via network link 1021 to a compatible LAN. Wireless links are also possible. In any such implementation, communication interface 1020′ sends and receives electrical, electromagnetic or optical signals which carry digital data streams representing various types of information.

Network link 1021 typically provides data communication through one or more networks to other data devices. For example, network link 1021 may provide a connection through local network 1022 to local server computer 1023 or to data equipment operated by ISP 1024. ISP 1024 in turn provides data communication services through the world wide packet data communication network now commonly referred to as the “Internet” 1025 Local network 1022 and Internet 1025 both use electrical, electromagnetic or optical signals which carry digital data streams. The signals through the various networks and the signals on network link 1021 and through communication interface 1020, which carry the digital data to and from computer 1000, are exemplary forms of carrier waves transporting the information.

Processor 1013 may reside wholly on client computer 1001 or wholly on server 1026 or processor 1013 may have its computational power distributed between computer 1001 and server 1026. Server 1026 symbolically is represented in FIG. 10 as one unit, but server 1026 can also be distributed between multiple “tiers”. In one embodiment, server 1026 comprises a middle and back tier where application logic executes in the middle tier and persistent data is obtained in the back tier. In the case where processor 1013 resides wholly on server 1026, the results of the computations performed by processor 1013 are transmitted to computer 1001 via Internet 1025, Internet Service Provider (ISP) 1024, local network 1022 and communication interface 1020. In this way, computer 1001 is able to display the results of the computation to a user in the form of output.

Computer 1001 includes a video memory 1014, main memory 1015 and mass storage 1012, all coupled to bi-directional system bus 1018 along with keyboard 1010, mouse 1011 and processor 1013.

As with processor 1013, in various computing environments, main memory 1015 and mass storage 1012, can reside wholly on server 1026 or computer 1001, or they may be distributed between the two. Examples of systems where processor 1013, main memory 1015, and mass storage 1012 are distributed between computer 1001 and server 1026 include thin-client computing architectures and other personal digital assistants, Internet ready cellular phones and other Internet computing devices, and in platform independent computing environments,

The mass storage 1012 may include both fixed and removable media, such as magnetic, optical or magnetic optical storage systems or any other available mass storage technology. The mass storage may be implemented as a RAID array or any other suitable storage means. Bus 1018 may contain, for example, thirty-two address lines for addressing video memory 1014 or main memory 1015. The system bus 1018 also includes, for example, a 32-bit data bus for transferring data between and among the components, such as processor 1013, main memory 1015, video memory 1014 and mass storage 1012. Alternatively, multiplex data/address lines may be used instead of separate data and address lines.

In one embodiment of the invention, the processor 1013 is a microprocessor such as manufactured by Intel, AMD, Sun, etc. However, any other suitable microprocessor or microcomputer may be utilized. Main memory 1015 is comprised of dynamic random access memory (DRAM). Video memory 1014 is a dual-ported video random access memory. One port of the video memory 1014 is coupled to video amplifier 1016. The video amplifier 1016 is used to drive the cathode ray tube (CRT) raster monitor 1017. Video amplifier 1016 is well known in the art and may be implemented by any suitable apparatus. This circuitry converts pixel data stored in video memory 1014 to a raster signal suitable for use by monitor 1017. Monitor 1017 is a type of monitor suitable for displaying graphic images.

Computer 1001 can send messages and receive data, including program code, through the network(s), network link 1021, and communication interface 1020. In the Internet example, remote server computer 1026 might transmit a requested code for an application program through Internet 1025, ISP 1024, local network 1022 and communication interface 1020. The received code maybe executed by processor 1013 as it is received, and/or stored in mass storage 1012, or other non-volatile storage for later execution. In this manner, computer 1000 may obtain application code in the form of a carrier wave. Alternatively, remote server computer 1026 may execute applications using processor 1013, and utilize mass storage 1012, and/or video memory 1015. The results of the execution at server 1026 are then transmitted through Internet 1025, ISP 1024, local network 1022 and communication interface 1020. In this example, computer 1001 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

What is claimed is:

1. A method for providing a program guide comprising:
selecting a program;
in a content extractor, obtaining metadata associated with the program;
defining a plurality of summary blocks of time of the program;
using the metadata, preparing a summary description for each summary block;
displaying the summary description during presentation of the summary block of the program.

2. The method of claim 1 wherein the metadata comprises closed captioning data.

3. The method of claim 2 wherein the closed captioning data is parsed to determine scene context.

4. The method of claim 3 wherein the scene context is used as the summary description.

5. The method of claim 2 wherein the closed captioning data is used to define summary blocks.

6. The method of claim 5 wherein the closed captioning data is used to extract scenes of the content.

7. The method of claim 6 wherein the scenes are defined as the summary blocks.

8. The method of claim 1 wherein the guide is associated with timestamps of the content.

9. The method of claim 1 wherein the guide and the content are displayed on the same display device.

10. The method of claim 1 wherein the guide and the content are displayed on separate display devices.
